(19) United States
(12) Patent Application Publication
(10) Pub. No.: US 2010/0306310 A1
(43) Pub. Date: Dec. 2, 2010

(54) METHOD AND SYSTEM FOR REGULATING BANDWIDTH

(75) Inventors: Kiam Heong Ang, Singapore (SG); Wilson Chandra Tjhi, Singapore (SG); Alexander Yap, Singapore (SG)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: YOKOGAWA ELECTRIC CORPORATION, Tokyo (JP)

(21) Appl. No.: 12/771,425

(22) Filed: Apr. 30, 2010

(30) Foreign Application Priority Data
May 29, 2009 (SG) 200903670-8

(51) Int. Cl. G06F 15/16; G06F 15/177

(52) U.S. Cl. 709/203; 709/222; 709/233

(57) ABSTRACT

The present invention provides a method and system for regulating bandwidth by regulating data transmission between a transmission station and a receiving station at an application level. By regulating bandwidth at the application level, there is no need for complicated network programming required at a low level, such as the device level, whenever changes to the bandwidth need to be made. As such, bandwidth can be easily regulated and customised without having to carry out complicated network programming.

### FIELD OF INVENTION

The present invention generally relates to network based communication, and in particular, to a method and system for regulating bandwidth.

### BACKGROUND

A network of computers and devices allows computers and devices to communicate with each other and share resources and information. The computers and devices are connected to each other by communication lines through which data is transmitted. Each communication line has a specific capacity (or bandwidth), which is generally measured in units of data per time for example, kilobits per second (kbps), and data is transmitted over the communication line at a specific transmission rate.

Users of a network for data communication often experience severe communication constraints due to non-optimal handling of the data transmission. This may be due to an inefficient use of the network bandwidth and/or a rate of data transmittal slower than necessary.

One way to utilise bandwidth effectively is by allowing data transmission even if it exceeds its specified transmission rate, provided there is available bandwidth not being utilised. In order to utilise bandwidth effectively, bandwidth control is needed.

For bandwidth control, it is necessary to police the specified transmission rate for each user and guarantee it. This is to ensure the communication quality of accommodated users of a network. Simultaneously, it is necessary to police and limit the peak transmission rate as a user group, which is a group binding the users of the network, to prevent congestion and protect the network bandwidth. Hence, each of the users can send and receive packets using any available bandwidth even when they have used up the specified transmission rate guaranteed for each of them, unless they exceed the peak transmission rate as a user group.

There exist systems and/or methods for bandwidth control to utilise bandwidth more effectively. An example of such a system and/or method is disclosed in U.S. Pat. No. 7,420,917, which teaches a bandwidth policing apparatus for performing bandwidth policing for each user group as well as performing bandwidth policing for each user. Another example is disclosed in U.S. Pat. No. 7,423,972, which teaches a system and method for a transmission rate controller to improve bandwidth use. Yet another example, which illustrates a system for bandwidth control, is disclosed in U.S. Pat. No. 7,231,455 which teaches a self-monitoring service system using a throttle mechanism to control usage of and data flow within the system and specifically, within a customer's environment.

Although the examples mentioned above disclose systems and/or methods for utilising bandwidth more effectively, the bandwidth control is carried out at a low level, for example at a device level. The disclosure in the prior art are not flexible and are restrictive. Further, when there is a change in policy or protocol, it requires complicated programming at the device level. Furthermore, the device driver is closely tied up with the hardware or operating system. Thus, when the operating system or bandwidth control policy requires updating, complex compatibility issues arise between the operating system and the device driver arise. In addition, in the prior arts systems, only one version of the device driver for the bandwidth control is allowed on one physical machine. This disadvantageously restricts all applications on the machine to use the same driver when different applications have different policies.

Therefore, there is a need for a method and system for regulating bandwidth, which substantially reduces the aforementioned disadvantages.

### SUMMARY

The preferred embodiment of the invention disclosed herein provides a method and system for regulating bandwidth by regulating data transmission between a transmission station and a receiving station at an application level. By regulating bandwidth at the application level, there is no need for complicated network programming required at a low level, for example at a device level, whenever modification to the bandwidth needs to be made. As such, bandwidth can be easily regulated and customised without having to carry out complicated network programming. Further, the invention allows multiple versions of communication library for the bandwidth control to be available on one physical machine for different applications to use different versions. This improves the flexibility and reduces the restriction of implementing changes in bandwidth regulation.

In accordance with a first aspect of the invention, there is disclosed a method for regulating bandwidth by regulating data transmission between a transmission station and a receiving station at an application level. Further, each of the transmission station and the receiving station has a communication library. The method comprises requesting configuration information from the receiving station communication library. The method also comprises configuring the transmission station communication library, based on the configuration information requested from the receiving station communication library. The method further comprises establishing connection between the transmission station communication library and the receiving station communication library for transmitting data, in which data is transmitted from the transmission station to the receiving station based on the configured transmission station communication library to thereby regulate bandwidth.

In accordance with a second aspect of the invention, there is disclosed a system for regulating bandwidth by regulating data transmission at an application level. The system comprises a transmission station having a transmission station communication library and a receiving station having a receiving station communication library. The receiving station communication library is in communication with the transmission station communication library and data is transmitted from the transmission station to the receiving station and data transmission is regulated by the transmission station communication library and the receiving station communication library to thereby regulate bandwidth.

In accordance with a third aspect of the invention, there is disclosed a system regulating bandwidth by regulating data transmission at an application level. The system comprises a transmission station having a transmission station communication library and a receiving station having a receiving station communication library, in which the receiving station communication library is in communication with the transmission station communication library. Further, the transmission station communication library performs the step of requesting configuration information from the receiving station communication library. It also performs the step of configuring the transmission station communication library based on the configuration information requested from the receiving station communication library. It further performs the step of establishing connection between the transmission station communication library and the receiving station communication library for transmitting data, in which data is transmitted from the transmission station to the receiving station based on the configured transmission station communication library to thereby regulate bandwidth.

### BRIEF DESCRIPTION OF THE DRAWINGS

Several preferred embodiments of the invention are described hereinafter with reference to the following drawings, in which:

FIG. 1 is a block diagram illustrating a system for regulating bandwidth according to a first embodiment of the invention;

FIG. 2 is a flow chart illustrating one preferred method for regulating bandwidth of the system of FIG. 1 according to the first embodiment of the invention;

FIG. 3 is a flow chart illustrating one preferred method for regulating bandwidth of the system of FIG. 1 according to a second embodiment of the invention; and

FIG. 4 is a flow chart illustrating one preferred method for regulating bandwidth of the system of FIG. 1 according to a third embodiment of the invention.

### DETAILED DESCRIPTION

A method and system for regulating bandwidth by regulating data transmission between a transmission station and a receiving station at an application level are described hereinafter for substantially reducing the foregoing disadvantages.

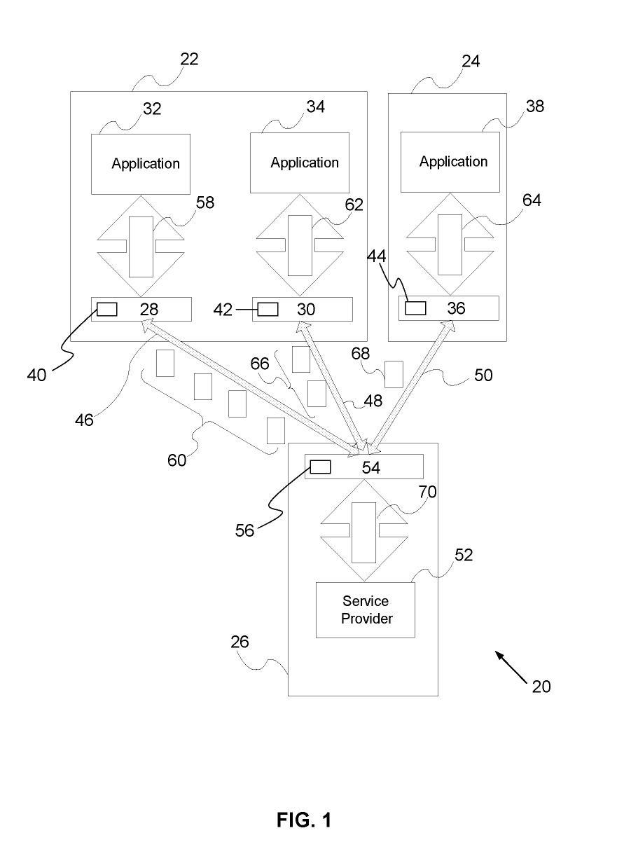

The several embodiments of the invention as described in the detailed description provided hereinafter are in accordance with FIG. 1 to FIG. 4 of the drawings, in which like elements are numbered with like reference numerals.

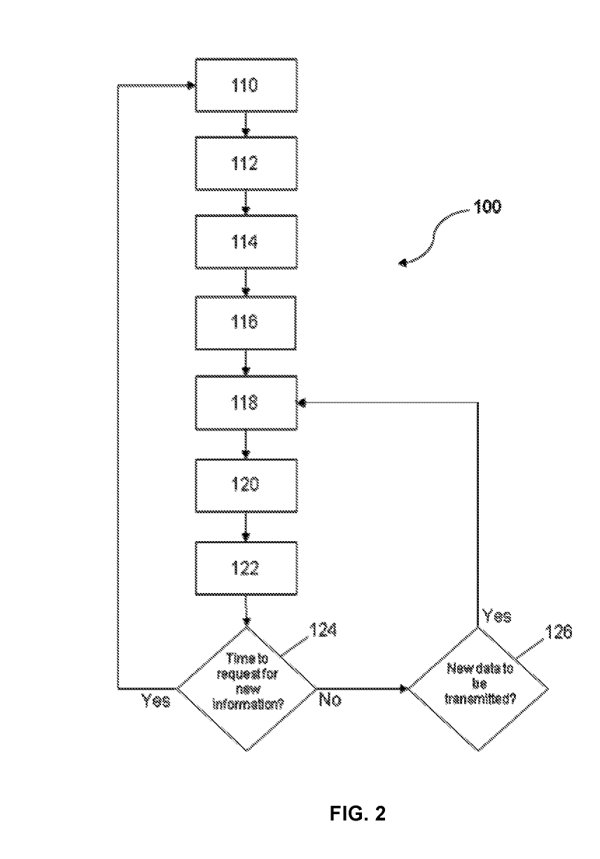

With reference to FIG. 1 and FIG. 2, a system 20 and a method 100 for regulating bandwidth are described according to a first embodiment of the invention. The system 20 for regulating bandwidth comprises transmission stations 22, 24, and a receiving station 26. The transmission station 22 comprises transmission station communication libraries 28, 30 and applications 32, 34, and the transmission station 24 comprises a transmission station communication library 36 and an application 38. Further, the transmission station communication libraries 28, 30, 36 comprise protocols 40, 42, 44, respectively, for regulation thereof. Examples of the transmission stations 22, 24 are client machines, which are computers accessing a remote service on another computer, a server machine, via a network.

The transmission stations 22, 24 are in communication with the receiving station 26 via communication lines 46, 48, 50. The receiving station 26, such as a server machine, comprises a service provider 52 and a receiving station communication library 54. A server machine is a computer that provides services to one or more other computers, known as client machines. Further, the receiving station communication library 54 comprises a protocol 56 for regulation thereof. The transmission station communication libraries 28, 30, 36 and the receiving station communication library 54 are common communication libraries utilised by the applications 32, 34, 38 and the service provider 52 to communicate with each other.

When the application 32 of the transmission station 22 wants to consume a service provided by the service provider 52, the application 32 initiates a connection request to the service provider 52 through the transmission station communication library 28. As illustrated in FIG. 2, the transmission station communication library 28 sends a request for configuration information to the receiving station communication library 54 via the communication line 46 in step 110. This step is transparent to both the application 32 and the service provider 52.

The configuration information comprises a plurality of pre-defined parameters for configuring the transmission station communication library 28. The plurality of pre-defined parameters is defined by the protocol 56 in the receiving station communication library 54. Examples of the pre-defined parameters include data packet size, data transmission rate and time span, which are pre-determined and defined by the protocol 56.

Next in a step 112, the receiving station communication library 54 verifies the protocol 56 based on its current load status and the user credentials of the application 32, and sends the configuration information to the transmission station communication library 28 via the communication line 46.

In a step 114, the transmission station communication library 28 is configured based on the configuration information requested from the receiving station communication library 54. The configuration is a self configuration performed by the transmission station communication library 28. After the transmission station communication library 28 has received the configuration information from the receiving station communication library 54, the protocol 40 is derived from the protocol 56. The transmission station communication library 28 must adhere to the protocol 40.

Next in a step 116, the transmission station communication library 28 establishes connection with the receiving station communication library 54 for transmitting data 58 from the transmission station 22 to the receiving station 26. The transmission station communication library 28 sends a connection request to the service provider 52 via the communication line 46 and the receiving station communication library 54 for establishing the connection. The configuration of the transmission station communication library 28 only lasts for a pre-determined time span defined by the protocol 56. In other words, the transmission station communication library 28 is configured to operate according to the configuration information pertaining to the data transmission rate only for the pre-determined time span, after which, the transmission station communication library 28 requires re-configuration based on new configuration information on the data transmission rate.

Once the connection between the transmission station communication library 28 and the receiving station communication library 54 is established, the transmission station communication library 28 splits the data 58 for transmission from the application 32 to the receiving station communication library 54 into data packets 60 in a step 118. The size of each of the data packets 60 does not exceed a pre-determined packet size, for example, one hundred kilo-bytes. The pre-determined packet size of each of the data packets 60 is defined by the protocol 56 in the receiving station communication library 54.

Next in a step 120, the transmission station communication library 28 sends the data packets 60 to the receiving station 26 via the communication line 46 and the receiving station communication library 54 based on a pre-determined data transmission rate defined by the protocol 56. An example of the pre-determined data transmission rate is thirty data packets per second. The pre-determined data transmission rate is defined by the protocol 56. Bandwidth is regulated by controlling the data transmission rate of the data packets 60. For instance, if there is a need to increase the bandwidth for a particular user or user group, the data transmission rate is easily modified at the application level to allow a larger number of packets to be transmitted per second. There is no need for complicated network programming required at a low level, for example a device level, in order to modify the data transmission rate. In this case, the data transmission rate is modified by modifying the protocol 56 directly instead of modifying hardware such as drivers and network cards.

After the data packets 60 are transmitted from the transmission station 22, to the receiving station 26, the data transmission is completed in a step 122. At the receiving station 26, the receiving station communication library 54 combines the data packets 60 for re-construction of the original data 58 into data 70 for transmission to the service provider 52. As the configuration of the transmission station communication library 28 only lasts for the pre-determined time span, there is a need for the transmission station communication library 28 to request new configuration information from the receiving station communication library 54 before the time span expires. For instance, the transmission station communication library 28 can request new configuration information when approximately 90% of the pre-determined time span has lapsed.

Next in a step 124, the transmission station communication library 28 determines whether it is time to request new configuration information pertaining to the data transmission rate. In the event where it is time to request new configuration information, the transmission station communication library 28 sends a request to the receiving station communication library 54 via the communication line 46 in the step 110 as previously described.

Subsequently, the steps 112, 114, 116, 118, 120 and 122 are performed and any remaining data 58 which has not been transmitted or any new data to be transmitted is then transmitted to the receiving station 26 based on the new data transmission rate.

In the event where it is not time to request for new configuration information, the transmission station communication library 28 determines whether there is any new data to be transmitted in a step 126. If there is new data to be transmitted, the transmission station communication library 28 will perform the steps 118, 120 and 122 and the new data is transmitted based on the current data transmission rate.

When the application 34 of the transmission station 22 and the application 38 of the transmission station 24 want to consume a service provided by the service provider 52, the applications 34, 38 initiate a connection request to the service provider 52. Similar to the transmission station communication library 28, the transmission station communication libraries 30, 36 send a request for configuration information to the service provider 52 via the communication lines 48, 80 and the receiving station communication library 54 in the step 110.

Subsequently, the steps 112, 114 and 116 are performed and connection between the applications 34, 38 and the receiving station 26 is established. Once connection is established, the transmission station communication libraries 30, 36 split data 62, 64 for transmission from the applications 34, 38 to the receiving station communication library 54 into data packets 66, 68 respectively, in the step 118. The transmission station communication libraries 30, 36 then send the data packets 66, 68 to the receiving station 26 via the communication lines 48, 50 and the receiving station communication library 54 in the step 120. The data transmission is completed in the step 122 after the data packets 66, 68 are transmitted to the receiving station 26. In the receiving station 26, the receiving station communication library 54 communicates with the service provider 52 via transmission of data 70. The data 70 is a reconstruction of the original data 58, 62 or 64,

The data transmission rate for each of the applications 32, 34, 38 varies according to the pre-determined data transmission rate defined by the protocol 56 for each of the user or user group. For instance, if a user using the application 32 is classified as high priority while another user using the applications 34, 38 is classified as low priority, the user using the application 32 is entitled to consume more resources from the service provider 52 and hence requires bigger bandwidth as compared to the user using applications 34, 38. The bandwidth for the user using the application 32 can be increased by easily modifying the data transmission rate defined in the protocol 56 to allow a larger number of data packets to be transmitted per second. Conversely, the bandwidth for the user using the applications 34, 38 can be decreased by modifying the data transmission rate to reduce the number of data packets to be transmitted per second.

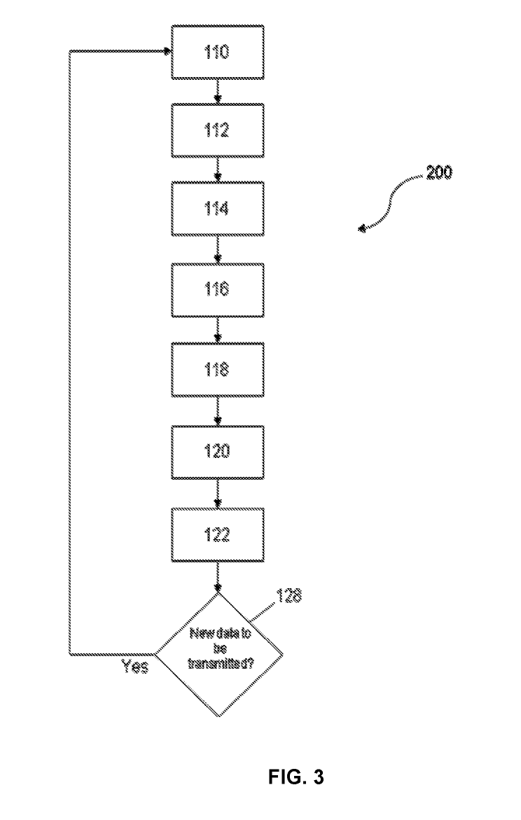

Alternatively, in a second embodiment of the invention, the protocol 56 can be modified such that there is no pre-determined time span. This is illustrated in FIG. 3 in a method 200. In the method 200, the steps 110, 112, 114, 116, 118, 120 and 122 are performed when data needs to be transmitted from the transmission station 22 to the receiving station 26. Once the data transmission is completed in the step 122, the transmission station communication library 28 determines whether there is any new data to be transmitted in a step 128. In the event where there is new data to be transmitted, the transmission station communication library 28 requests the data transmission rate at which it is allowed to transmit the new data in the step 110 as previously described.

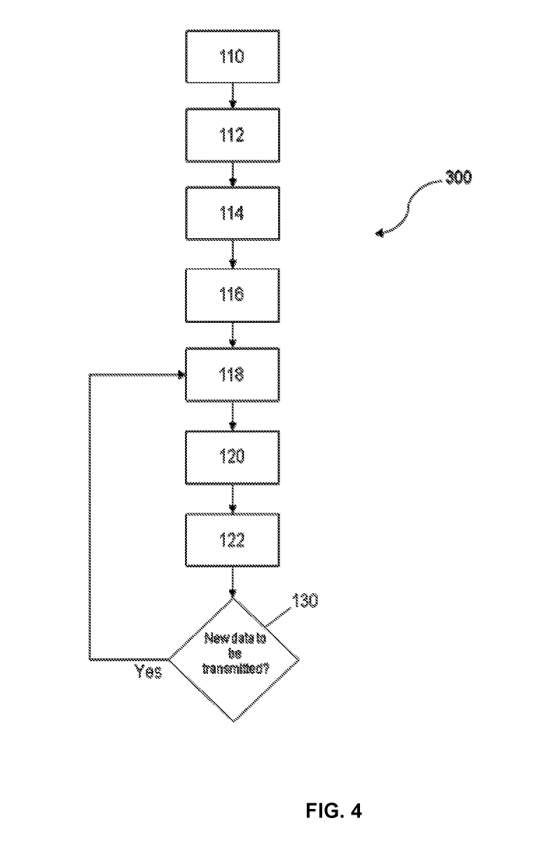

Alternatively, a third embodiment of the invention is illustrated in FIG. 4 as a method 300, in which the protocol 56 can be modified such that there is no time span restriction. In other words, once the transmission station communication library 28 receives the data transmission rate from the receiving station communication library 54, all the data 58 is transmitted based on the data transmission rate until the application 32 or the service provider 52 terminates the session.

In the method 300, the steps 110, 112, 114, 116, 118, 120 and 122 are performed when the data 58 needs to be transmitted from the transmission station 22 to the receiving station 26. Once the data transmission is completed in the step 122, the transmission station communication library 28 determines whether there is any new data to be transmitted in a step 130. In the event where there is new data to be transmitted, the transmission station communication library 28 splits the new data into data packets in the step 118 and the data packets are transmitted based on the current transmission rate in the step 120.

In the foregoing manner, a method and system for regulating bandwidth by controlling the data transmission rate of data packets at an application level are described according to several embodiments of the invention for addressing the foregoing disadvantages. Although a few embodiments of the invention are disclosed, the invention is not to be limited to specific forms or arrangements of parts so described and it will be apparent to one skilled in the art in view of this disclosure that numerous changes and/or modification can be made without departing from the scope and spirit of the invention as expressly set forth in the following claims.

1. A method for regulating bandwidth by regulating data transmission between a transmission station and a receiving station at an application level, each of the transmission station and the receiving station having a communication library, the method comprising:
requesting configuration information from the receiving station communication library;
configuring the transmission station communication library based on the configuration information requested from the receiving station communication library; and
establishing connection between the transmission station communication library and the receiving station communication library for transmitting data,
wherein data is transmitted from the transmission station to the receiving station based on the configured transmission station communication library to thereby regulate bandwidth.

2. The method for regulating bandwidth according to claim 1, wherein the configuration information comprises a plurality of pre-defined parameters for configuring the transmission station communication library.

3. The method for regulating bandwidth according to claim 2, wherein the plurality of pre-defined parameters is defined by a protocol in the receiving station communication library.

4. The method for regulating bandwidth according to claim 2, wherein the plurality of pre-defined parameters comprises a pre-determined data packet size, a pre-determined data transmission rate and a pre-determined time span.

5. The method for regulating bandwidth according to claim 4, the method further comprising splitting the data to be transmitted from the transmission station to the receiving station into data packets, wherein the size of each of the data packets does not exceed the pre-determined data packet size defined by the protocol.

6. The method for regulating bandwidth according to claim 5, the method further comprising transmitting the data packets from the transmission station to the receiving station at the pre-determined data transmission rate defined by the protocol.

7. The method for regulating bandwidth according to claim 4, wherein the configuration of the transmission station communication library lasts for the pre-determined time span.

8. The method for regulating bandwidth according to claim 7, wherein when the pre-determined time span expires, the method further comprises retrieving new configuration information from the receiving station communication library.

9. The method for regulating bandwidth according to claim 1, wherein the transmission station comprises at least one application.

10. The method for regulating bandwidth according to claim 9, wherein the transmission station is a client machine.

11. The method for regulating bandwidth according to claim 1, wherein the receiving station comprises a service provider.

12. The method for regulating bandwidth according to claim 11, wherein the receiving station is a server machine.

13. A system for regulating bandwidth by regulating data transmission at an application level comprising:
a transmission station having a transmission station communication library; and
a receiving station having a receiving station communication library, the receiving station communication library in communication with the transmission station communication library,
wherein data is transmitted from the transmission station to the receiving station and data transmission is regulated by the transmission station communication library and the receiving station communication library to thereby regulate bandwidth.

14. The system for regulating bandwidth according to claim 13, wherein the transmission station communication library comprises a protocol for regulation thereof.

15. The system for regulating bandwidth according to claim 13, wherein the receiving station communication library comprises a protocol for regulation thereof.

16. A system for regulating bandwidth by regulating data transmission at an application level comprising:
a transmission station having a transmission station communication library; and
a receiving station having a receiving station communication library, the receiving station communication library in communication with the transmission station communication library,
wherein the transmission station communication library performs the steps of:
requesting configuration information from the receiving station communication library;
configuring the transmission station communication library based on the configuration information requested from the receiving station communication library; and
establishing connection between the transmission station communication library and the receiving station communication library for transmitting data,
wherein data is transmitted from the transmission station to the receiving station based on the configured transmission station communication library to thereby regulate bandwidth.
